(19) United States
(12) Patent Application Publication
(10) Pub. No.: US 2017/0099985 A1
(43) Pub. Date: Apr. 13, 2017

(54) Insulating Implement for cooking use

(71) Applicant: Ross J. Vagnieres, Albuquerque, NM (US)

(72) Inventor: Ross J. Vagnieres, Albuquerque, NM (US)

(21) Appl. No.: 14/877,855

(22) Filed: Oct. 7, 2015

(51) Int. Cl. A47J 36/36; A47J 45/08; A47J 36/06

(52) U.S. Cl. CPC A47J 36/36; A47J 36/06; A47J 45/085

(57) ABSTRACT

A kitchen or barbecue apparatus for cooking use is composed of a heat-resistant and insulating material having temperature control characteristics. Such a material forms the apparatus from at least one sheet having a soft and flexible surface providing a topside cover for any pot, pan or vessel used in cooking or heating of a substance. This material may be fabric that may be chemically treated or it may be naturally self-extinguishing such as wool felt, or may be a molded material such as plastic or silicone. The material is die cut, fabricated, or molded to the shape of a useful apparatus such as to fit over the top of any pot, pan or cooking vessel that heats up in the cooking process. The apparatus is adapted to allow for any handles pulls, or holders which exist on the topside portion of the heating apparatus which this apparatus will cover.

### BACKGROUND OF THE INVENTION

1. Field of the Invention

The present invention relates to cooking vessels as it provides insulation, energy conservation, and improvements in cooking temperature consistency, for a variety of hot or cold articles such as cooking pots, pans, lids, barbecue grills, barbecue kettles, smokers, crock pots, slow cookers, pressure cookers, as well as camping ovens or the like. The present invention also adds protection to the cook against burns while cooking

2. Brief Description of the Prior Art

Energy conservation is an important objective and promises to continue to be one of the main steps toward a sustainable future. Commonly used heat sources used for cooking include electric, wood, pellets, and natural gas, powered mostly from fossil fuel, wood, and nuclear fuel sources. 0These sources are harmful to the environment and will eventually be extinguished. Another problem with conventional cooking heat sources is that they are very energy inefficient in that much of the energy is lost to the surrounding environment in the cooking process.

As liquids and gases become warmer, the density decreases, which tends to make them lighter, so that they rise. By this principle, most of the waste heat in a building escapes through the roof, and likewise, most energy loss in cooking pots and pans is lost through the top of the pan, also called the lid. Sometimes the thickness of the lid is thinner than the sides and bottom of the pan, which contribute to the heat loss by more easily conducting the heat out of the pan. This energy loss is most significant outdoors, or in the summer indoors when the home/kitchen area is already being mechanically cooled, which is even more costly than heating a building. The heat added for cooking, then needs to be removed again by the cooling system. Outside, the heat is directly lost to the surrounding environment.

Currently there seems to be no product on the market which addresses this need to save wasted energy. The closest product existing today are products that keep foods cool or warm, such as thermos, snuggy's and the like. The only way to help keep heat inside a cooking container while hot is to place objects found nearby on top. Hot pads don't fit well as they are not designed for this purpose, wont cover the surface well, and can easily fall off risking a fire.

A dish towel can be folded up and placed on top of the container, but again it can easily unfold and fall into the flames causing a fire, possibly when no-one is around. A towel with corners hanging precariously over the edge can get caught under the lid, preventing it from closing tightly. It also takes extra time to fold a dish towel and keep refolding it each time the container is opened for stirring or observations. And also, once folded and placed, the dish towel is not available for use as a dish towel any longer. Lastly, a folded dish towel or hot pad placed over a lid will make it difficult to use the lid handle.

U.S. Pat. No. 6,550,271B2 is a decorative thermally insulated beverage bottle holder. It is made of soft flexible insulating material such as neoprene, and uses a zipper to hold it in place.

While it keeps heat out of a cold bottled drink, it doesn't keep heat in for any type of cooking process. The zipper can allow energy to pass through, and its unclear if energy is saved.

U.S. Pat. No. 5,195,500 is a self contained oven device that is meant to capture some of the waste heat that is lost around a pan or cooking vessel during the cooking process. Once captured, this heat is directed around the pan in hopes that more of the waste heat enters the pan through the sides before it exits through the top of the device.

Although the device covers the provided vessel like a secondary vented lid, its main purpose is not to provide insulation over an existing lid of a cooking vessel. Therefore, there is still heat lost through the top of the device, where most heat loss occurs. The device is more complicated with more faces than the present invention, and possibly requires an internal support structure. Still a hot pad must be used as insulator for the cook to hold the handle to raise the lid and check the contents. Finally, it does not double as a hot pad nor can it be washed in an automatic washing machine.

U.S. Pat. No. 6,105,811 is a pan cover or lid, which is intended for venting steam and preventing boil over for pots, pans and cooking vessels which do not have a lid, or a lid that allows venting of steam.

While the device may provide some insulation value, it also has holes which allow heat in the form of hot air or steam to escape, thereby counteracting any insulation value. The pan cover device would not double as a hot pad, nor would it stack and store compactly.

U.S. Pat. No. 4,388,743 is a removable heat insulating cover for a cooking vessel lid handle. As intended it will provide insulation protection to the cook's hand while grabbing the handle and lifting off the lid to view contents inside the vessel.

Providing insulation value around the handle is the patents limit. It does not cover the vessel lid entirely. In fact it hardly provides any insulation value at all to the rising heat inside the vessel. This would not save energy, save money, or reduce greenhouse gases. Finally, it does not double well as a hot pad on the counter nor can it be washed in an automatic washing machine.

### SUMMARY OF THE INVENTION

A kitchen or barbecue apparatus for cooking use is composed of heat-resistant and insulating material having temperature control characteristics. Such a material forms the apparatus from at least one sheet having a soft and flexible surface providing a topside cover for any pot, pan or vessel used in cooking or heating of a substance. This material may be fabric which may be chemically treated or it may be naturally self-extinguishing such as wool felt, or may be a molded material such as plastic or silicone. The material is die cut, fabricated, or molded to the shape of a useful apparatus such as to fit over the top of any pot, pan or cooking vessel that heats up in the cooking process. The apparatus is adapted to allow for any handles pulls, or holders which exist on the topside portion of the heating apparatus which the present invention will pair with.

The present invention is directed to a cooking apparatus, which not only increases the efficiency of cooking in pots, pans and other cooking vessels by adding thermal insulation in key areas, but increases control of the heat levels for the cook, while providing thermal insulation comfort for the cook's hands when stirring or observing what is being cooked. The insulating device is adapted for use with lids and tops that have handles of all different sizes and shapes, as well as no handles at all or handles on the side, such as cooking pots. Custom units can also be made to fit outdoor cooking apparatus such as barbecues and slow cookers. The outdoor cookers come in countless shapes and sizes, some with temperature gages and air vent holes, so a high production “one size fits all” is not likely practical. Custom manufactured units will work just fine, where the invention is designed to fit a specific model or set of models.

One of the primary advantages of the invention is that it can be used in many different situations, such as in restaurants, conventions, catering events, at home and while camping to increase the thermal efficiency while cooking This helps to preserve scarce resources using a simple and relatively inexpensive oven device which reduces the heat loss over the covered pot or pan thus permitting the use of a lower energy output setting at the heat source. This thermal device may also be useful in regions of the world where cooking fuel, such as wood, is scarce.

Accordingly, the present invention provides thermal insulating cooking implements which present the objects and advantages listed below:

An object of the present invention is to provide insulation against heat loss incurred in the cooking process.

Another object of the present invention is to provide such implements that are naturally fire retardant or treated with fire retarding chemicals.

Another object of the present invention is to provide protection to the hands and fingers of a cook or other person from injury due to excessive hot temperatures.

Another object of the present invention is to provide such implements that are compact and are not bulky, unsightly or distracting.

Another object of the present invention is to provide such implements that fit nicely over the lid and don't get in the way by getting caught under the lid when replacing the lid back down.

Another object of the present invention is to provide such implements that fold nicely for storage.

Another object of the present invention is to provide such implements that fold and can be hung off the wall or under cabinet surfaces by means of a hook of any sort.

Another object of the present invention is to provide such implements that are attractive looking in design, color and texture.

Another object of the present invention is to provide such implements that feel good to the touch by the hand and fingers.

Another object of the present invention is to provide such implements that can be cleaned by hand or in a washing machine.

Another object of the present invention is to provide such implements that saves energy thus saving the owner money.

Another object of the present invention is to provide such implements that saves energy thus reducing greenhouse gases.

Another object of the present invention is to provide such implements that saves energy thus extending society's energy supply.

### BRIEF DESCRIPTION OF THE DRAWING FIGURES

FIG. 1 shows a perspective view of the typical use of the present invention being placed on top of a typical pot in a typical kitchen cooking situation;

FIG. 2 shows a front elevation view of the present invention in its open, functional configuration;

FIG. 3 shows a plan view of the present invention in its opened configuration;

FIG. 4 shows a cross sectional view of the present invention shown in FIG. 3 as taken in the direction of arrows 4-4 thereof;

FIG. 5 shows a plan of the present invention in its opened configuration with a lid handle slipped in place;

FIG. 6 shows a side elevation view of the present invention in its folded configuration, hanging from a wall;

FIG. 7 shows a plan (top) view of the present invention in its folded configuration, ready for storage;

FIG. 8 shows a side elevation view of the present invention in its folded configuration, hanging from a wall;

FIG. 9 shows a perspective view of different embodiment of the present invention;

FIG. 10 shows a perspective view of the present invention as shown in FIG. 9, folded and used as a hot pad;

FIG. 11 shows a perspective view of different embodiment of the present invention;

FIG. 12 shows plan (top) view of a different embodiment of the invention in its folded configuration, ready for storage;

FIG. 13 shows a front elevation view of a different embodiment of the present invention in its open, functional configuration;

FIG. 14 shows a plan (top) view of a different embodiment of the present invention in its open, functional configuration.

FIG. 15 shows a plan (top) view of a pattern for fabrication of the present invention.

FIG. 16 shows a plan (top) view of a different embodiment of the present invention.

FIG. 17 shows a cross sectional view of the present invention shown in FIG. 15 as taken in the direction of arrows 17-17 thereof.

FIG. 18 shows a perspective view of a different embodiment of the present invention.

Listing of Reference Numerals in the Drawings

| | | | |
|---|---|---|---|
| 20 | the present invention; | 22 | working pattern; |
| 24 | flange; | 26 | stitch seam; |
| 28 | stitch seam end A; | 30 | stitch seam end B; |
| 32 | top flange edge; | 34 | side edge; |
| 36 | hand; | 38 | typical pot or cooking vessel; |
| 40 | lid handle; | 42 | perimeter of the cooking vessel; |
| 44 | die cut hole; | 46 | loop; |
| 48 | baking dish; | 50 | heat rising; |
| 52 | wall mounted hook; | 54 | butted connection; |
| 56 | butted connection end; | 60 | additional working pattern; |
| 62 | insulation layer; | 64 | pouch, pocket, opening for handle; and |

| | |
|---|---|
| 66 | ribs, shapes, or design features. |

### DETAILED DESCRIPTION OF THE PRESENT INVENTION

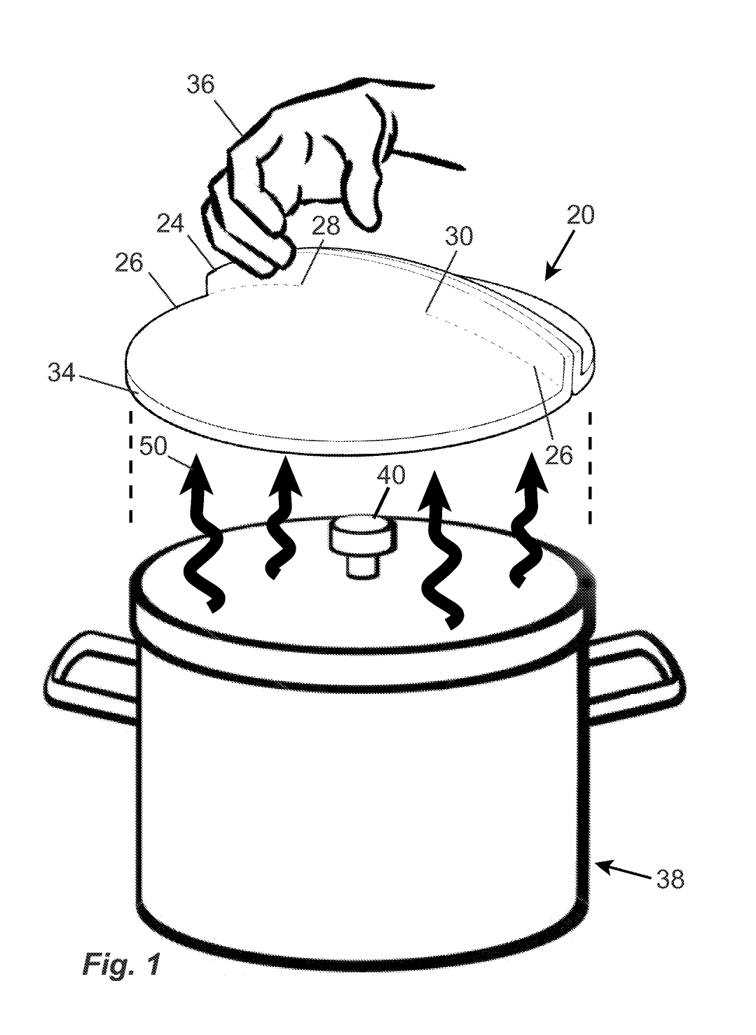

Almost all heat used in cooking escapes via heat transfer to the immediate surroundings. In some cases the maximum temperature of the vessel and ingredients is limited when the heat lost equals the heat supplied from the heat source. The heat loss during cooking 50 also slows down the cooking process by taking more time to heat the cooking vessel, and the food. Hot air and gases rise because the molecules are farther apart, which makes the them lighter. This tells us that most heat is lost 50 through the top of the pan, as is also the case in buildings. The preferred embodiment of the present invention is to act as an insulating blanket or cover which is placed on top of the lid of a cooking vessel such as pot, pan, grill or the like as shown in perspective view of the present invention 20 in FIG. 1.

The invention acts like a jacket on top as insulator as it significantly reduces the amount of heat loss 50 out the top. As an insulator, the present invention saves energy and thus reduces greenhouse gases and costs to the owner. Higher temperatures can be reached and the maximum temperature be attained more quickly.

FIG. 1 shows a perspective view of the preferred embodiment of the present invention as being placed over the lid of the pot in a typical cooking use. The user will hold the invention 20 by the flange 24 while placing on the pot lid. The other hand will adjust and assist in proper placement. Once placed onto the lid of a cooking vessel 38 pushing down and a little wiggle, the lid handle 40 slips into the flange 24, between the ends of the stitch area 28 and 30. Thus the handle 40 helps hold the invention 20 in place. The side edge 34 will sit close to the perimeter of the typical cooking vessel 42.

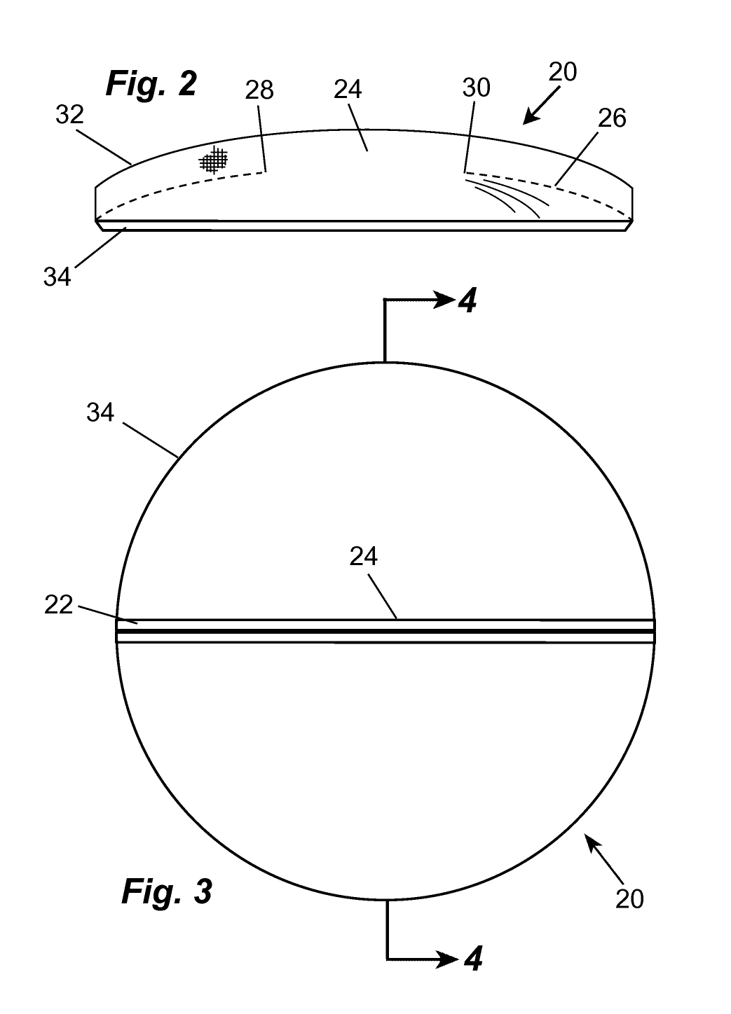

FIG. 2 shows a front elevation view with the stitched area missing between stitch line end 28 and stitch line end 30, as in some embodiments. The unstitched (unconnected) area 28-30 will allow a lid handle to protrude through snuggly, and is wide enough to accommodate most sizes and shaped handles. FIG. 3 shows a plan (top) view. In some embodiments the top edge 32 of the flange 14 runs across at the middle where there is a seam joining two sheets 22. In other embodiments the two sheets can be attached with fasteners, adhesives, polyepoxides, heat welding, hook and loop, etc.

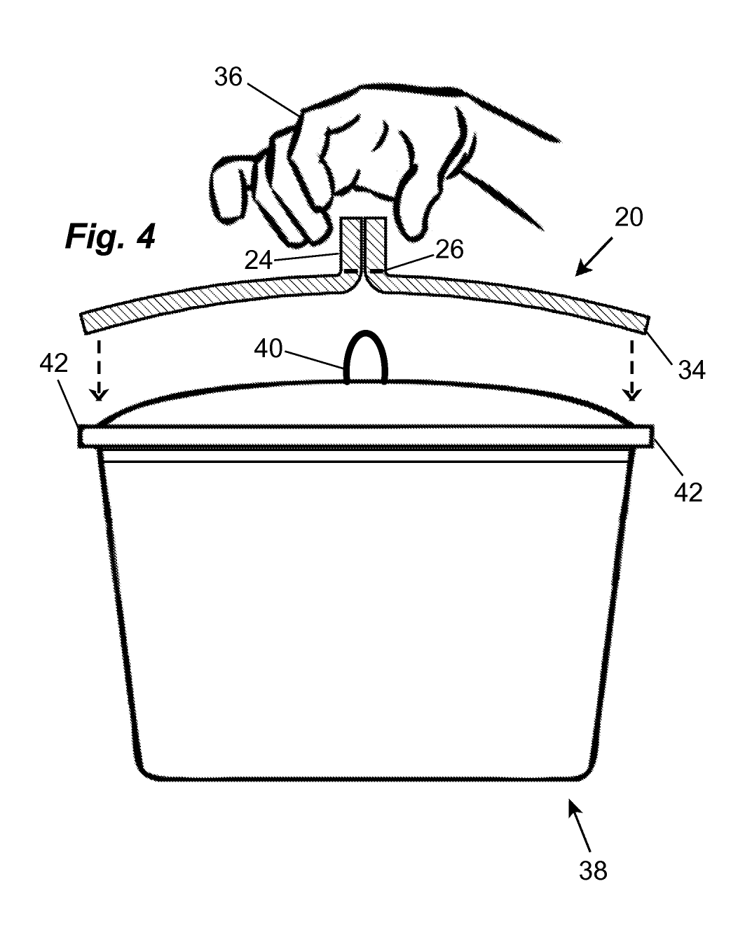

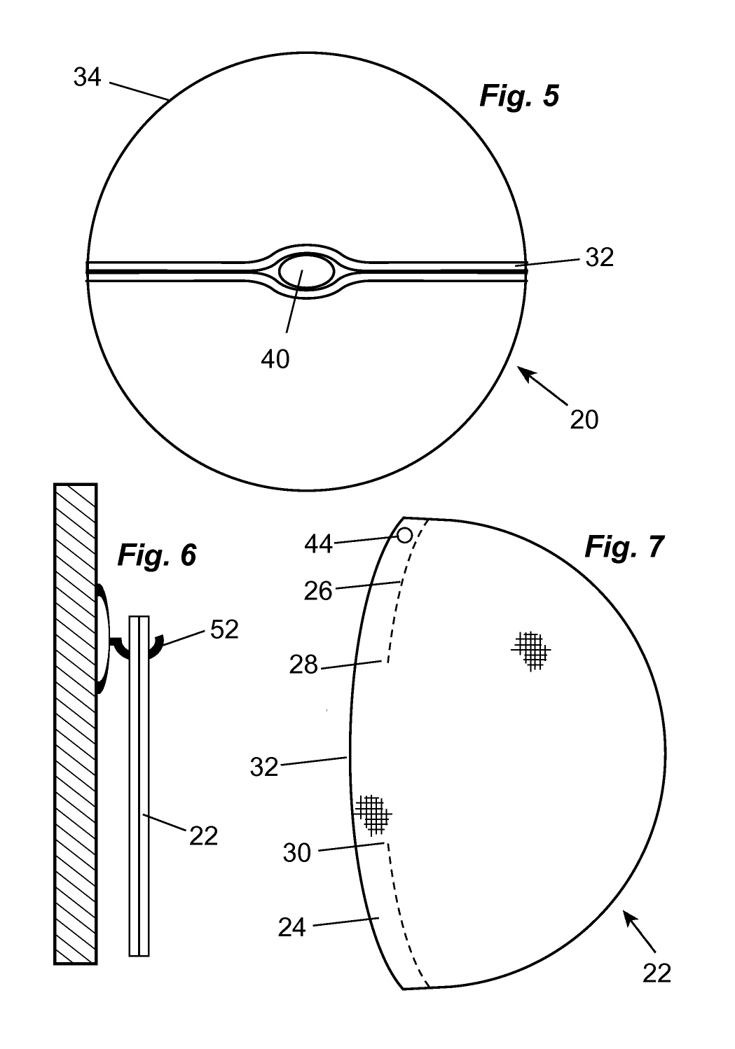

The section view as denoted in lines 4-4, in FIG. 3 is shown in FIG. 4. Again, a hand 36 shows a typical operation of holding over the pot 38 followed by pressing down snuggly over the lid handle 40 thus helping place and keep the invention in place, while minimizing heat loss. In most embodiments the edge 34, generally follows as close to adjacent to the perimeter 42 of the pot 38 as possible and practical. In FIG. 5 a plan(top) view of the invention in use 20 shows how the flange 32 separates and fits snuggly around lid handles 40, knobs and grips.

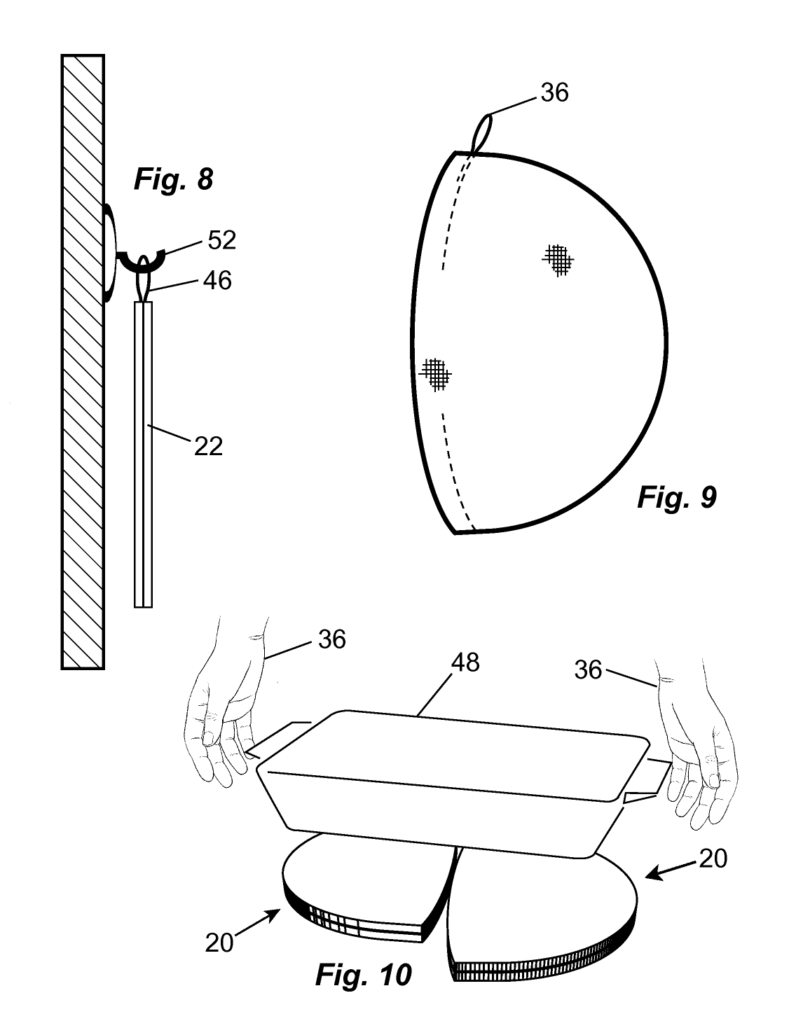

FIG. 6 shows the invention as hung off a nail or hook, which would be commonly found in a kitchen or pantry, wall or the like. This is discussed further in FIG. 7, which shows the shape of the die cut piece used in construction. In many embodiments two identical die cut sheets, normally between 0.80 mm to 25.4 mm thick material, are stitched, glued or attached together in some similar way at the dotted stitch line 26. This created the flange 24 which contains the unstitched open area between stitch end 28 and stitch end 30, which accommodates most shapes and sizes of lid handles 40. If the material used, such as wool or any flame retardant fabric is identical on both surface sides, then a hole 44 can also be die cut or punched. The holes then would be lined up before stitching them together 26. In other embodiments a material can be used that is different on both sides and a loop 46 can be attached inside the flange 24 where two die cut sheets 22 come together as shown in FIGS. 8 and 9. FIG. 8 shows the present invention hanging from the said loop 46 in FIG. 8 off a nail or hook, which would be commonly found in a kitchen or pantry, kitchen wall or the like.

In many embodiments the present invention can be used as hot pads for hot cooking vessels such as pots, pans, baking dishes, teapots, coffee pots, and the like, as shown in perspective view FIG. 10. In this instance two of the devices 10 are shown laying flat on a surface such as a counter top, and a baking dish 48 lowered to rest on top of them.

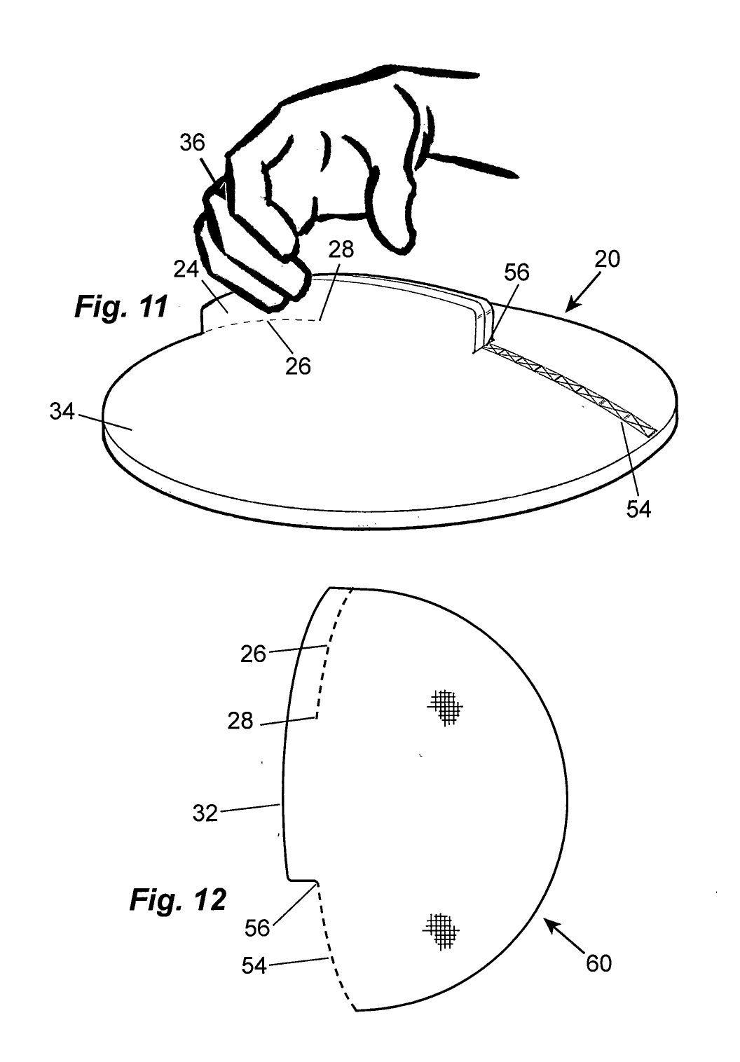

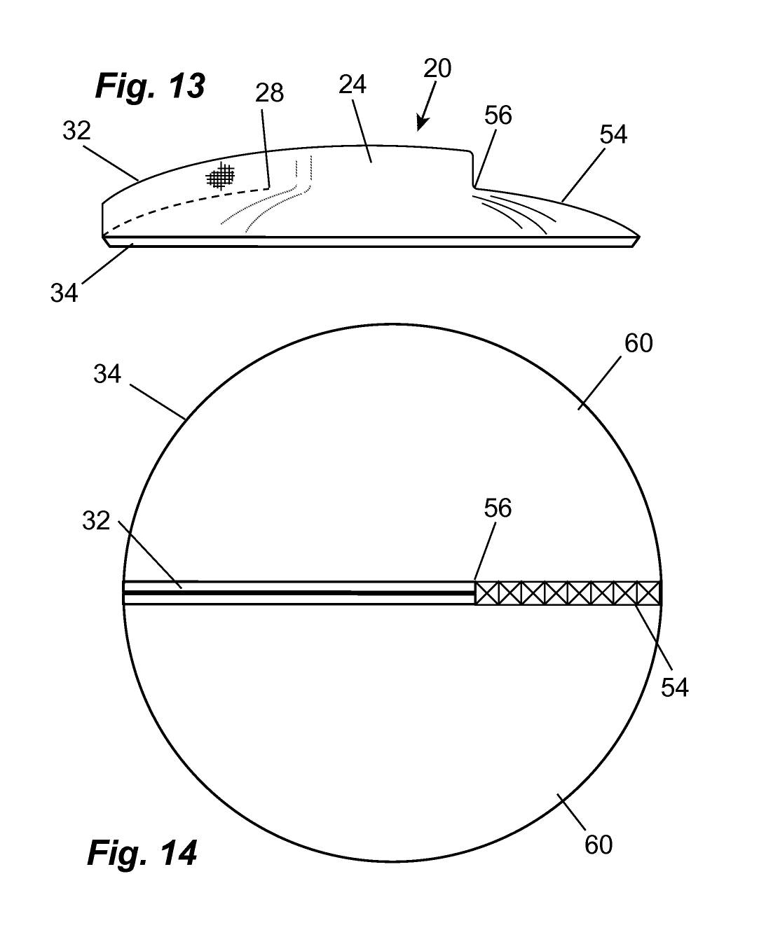

FIG. 11 shows a perspective view of another embodiment of the present invention as being placed over the lid of the pot in a typical cooking use. The user will hold the invention 20 by the flange 24 while placing on the pot lid. The other hand will adjust and assist in proper placement. FIG. 12 shows the shape of the die cut sheet used in construction. In many embodiments two identical die cut sheets, normally between 0.80 mm to 25.4 mm thick material, are stitched, glued or attached together in some similar way at the dotted stitch line 26. The second dotted line 54 again shows the butted joint. This created the flange 24 which contains the unstitched open area between stitch end 28 and stitch end 56, which accommodates most shapes and sizes of lid handles. FIG. 13 shows a front elevation view of the embodiments described in FIG. 11 with the stitched area missing between stitch line end 28 and stitch line end 56, as in some embodiments. The unstitched (unconnected) area 28-56 will allow a lid handle to protrude through snuggly, and is wide enough to accommodate most sizes and shaped handles. FIG. 14 shows a plan (top) view of the embodiments described in FIG. 11. In some embodiments the top edge 32 of the flange 24 runs across at the middle where there is a seam joining two sheets 60. In other embodiments the two sheets can be attached with fasteners, adhesives, polyepoxides, heat welding, hook and loop, etc.

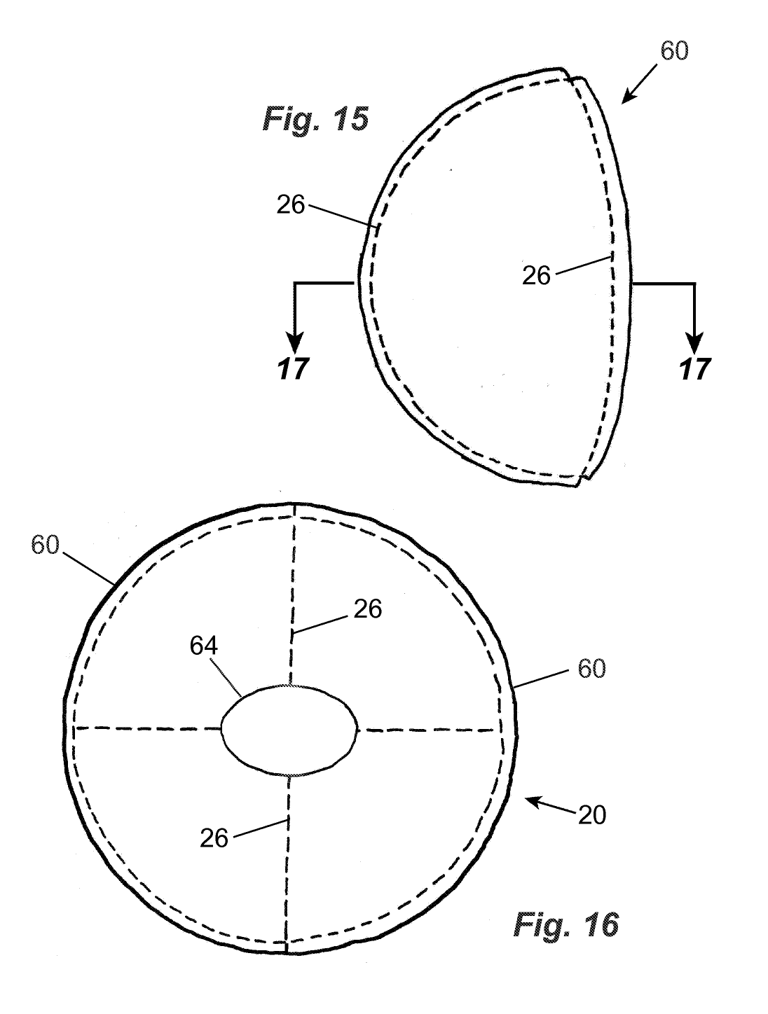

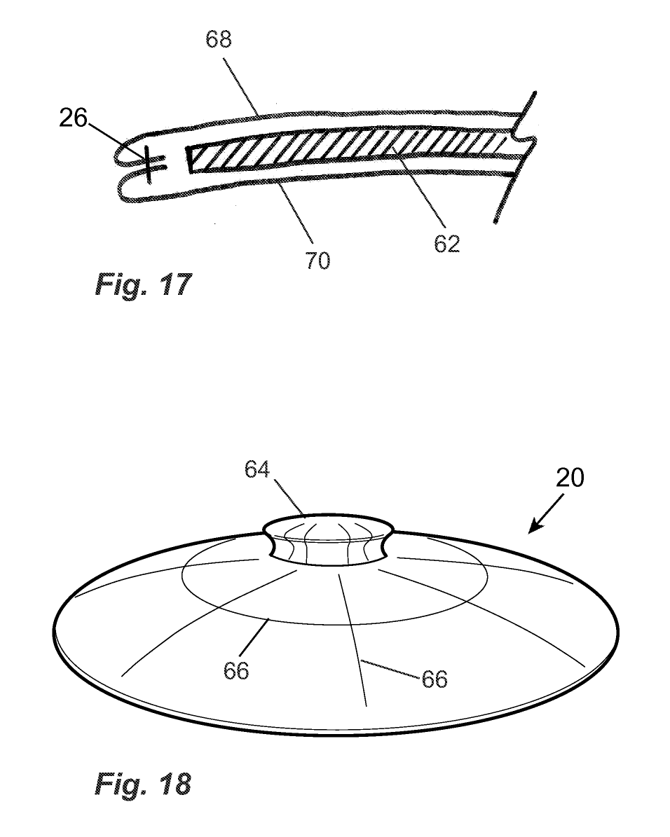

FIG. 15 shows another shape of the die cut piece 60 used in construction of the present invention. In some embodiments two similar die cut sheets, an upper sheet and a lower sheet, normally between .80mm to 25.4mm thick naturally fire retardant or treated material, are stitched, glued or attached together in some way at the dotted stitch line 26 so they are parallel and adjacent to each other. In these embodiment's, either top, bottom sheet or both will have color, texture, or design elements dyed in, printed on, sewn in as embroidery, or decorated in some other way, as well as a gripping substance, which can be composed of materials such as rubber, polyurethane, silicone, synthetic rubber, vinyl, or the like. The section view arrows with 17-17 delineate a section view described in FIG. 17.

FIG. 16 is a plan (top) view which shows how two of the patterns shown in FIG. 15 after they have been stitched, glued, or attached together. The oval in the center 64 represents a pouch, pocket, or envelope shape to account for lid handles, knobs and grips.

The section view as denoted in lines 17-17, in FIG. 15 is shown in FIG. 17. The cutaway view shows the top sheet stitched to the bottom sheet using a standard stitch 26 such as a plain, welt, or French seam, but could be any suitable method of attachment which allows a space for an optional insulating sheet 62 to fit inside, made from naturally fire retardant or treated material normally between 0.80 mm to 50.8 mm thick. In another embodiment, one or both of the top or bottom sheets can provide insulation qualities itself, thereby eliminating the need for an insulating layer between the sheets.

In yet another embodiment, FIG. 18 shows a perspective view of the present invention as fabricated out of a polymer material, normally between 0.80 mm to 50.8 mm thick.

The manufacturing process might be one of many typical types such as injection molded, rotational molded, vacuum formed, cast, or heat pressed. The heat resistant polymer used could be one of many available such as natural rubber, synthetic rubber, polyurethane, vinyl, polyester, silicone, silicone rubber, neoprene, rigid or soft foams, and the like. It can even be made out of recycled rubber such as vehicle tires or even erasers. In this process of fabrication, the surface could be smooth or many shapes 66 and textures 66 would be designed in to the surface such as ridges, ribs, bumps, valleys, bowls, dips and the like. A pouch, pocket, envelope or some other similar shape 64 would be fabricated in to the present invention to account for lid handles, knobs, grips and the like.

It can be appreciated that the present invention may be made of any suitable fire retardant or fireproof material in any number of pleasing colors. Further, preferably during fabrication of the device, a decorative upper surface texture and/or design pattern may be provided to enhance the aesthetic appearance of the overall unit.

Inasmuch as the present invention is subject to many modifications, variations and changes in detail, it is intended that the preceding description be interpreted as merely illustrative and not in a limiting sense.

Reference in the specification to “an embodiment,” “one embodiment,” “many embodiments” “some embodiments,” and “other embodiment” means that particular feature, structure, or characteristic described in connection with the embodiments is included in at least some embodiments, but not necessarily all embodiments. The various appearances of “an embodiment,” “one embodiment,” “many embodiments” “some embodiments,” and “other embodiments” are not necessarily all referring to the same embodiments. If the specification states a component, feature, structure, or characteristic “may,” “might,” or “could” be included that particular feature, component, structure, or characteristics not required to be included. If the specification or claims refer to “an additional” element, that does not preclude there being more than one of the additional elements.

While certain exemplary embodiments have been described and shown in the accompanying drawings, it is to be understood that such embodiments are merely illustrative of and not restrictive on the broad invention, and that this invention not be limited to the specific constructions and arrangements shown and described since various other modifications may occur to those skilled in the art.

What is claimed is:

1. A cooking apparatus comprising: a pair of sheets having identical configurations and residing next to each other in the folded position so as to provide common edge marginal regions about a common and coextensive periphery; the sheets having same or similar surfaces; said sheets being characterized as heat and cold temperature resistant and naturally fire retardant or chemically treated to be fire retardant; the sheets being measured as somewhere between 0.80 mm to 25.4 mm thick; stitching about the edge marginal region with a termination of the stitching defining an opening adjacent to a flange near the center to account for handles, hand grips, and knobs; each of the sheets opens out normally forming an open, slightly curved, spherical dome shape which follows the contour of most pots, pans and cooking vessel tops, covers and/or lids.

2. The cooking apparatus defined in claim 1 wherein the attachment method about the common edge marginal region consisting of hook and loop, rivets, grommets, snaps, buttons, adhesive or the like.

3. The cooking apparatus defined in claim 1 including a hole punched through the sheets adjacent to the flaps for branding tags and/or for removably supporting the sheets from a support member.

4. The cooking apparatus defined in claim 1 including a loop attached to the sheets adjacent to the flanges for removably supporting the sheets from a support member and/or to attach branding tags.

5. The cooking apparatus defined in claim 1 including the sheets composed of crochet, knitting, macrame, lace, trim, or the like.

6. The cooking apparatus defined in claim 1 including the flange that continues out to the coextensive periphery perimeter or instead be replaced with a butted stitch or connection;

7. The cooking apparatus defined in claim 1 including the flange which continues out to the coextensive periphery perimeter in one direction and is replaced with a butt stitch (or any type of butted attachment) in the other direction.

8. The cooking apparatus defined in claim 1 including the flange surface, the top surface, the underside surface or any other suitable surface covered with a gripping substance, which can be composed of materials such as rubber, polyurethane, silicone, synthetic rubber, vinyl, or the like.

9. A cooking apparatus comprising: a pair of sheets having identical configurations and residing parallel to each other so as to provide common edge marginal regions about a common and coextensive periphery; the sheets being characterized as heat and cold temperature resistant material and naturally fire retardant or chemically treated to be fire retardant; the sheets each being measured as somewhere between 0.0025 mm to 12.7 mm thick; the stitching about the center marginal region with a termination of the stitching and material defining opening to account for handles and knobs.

10. The cooking apparatus defined in claim 9 wherein stitching about the center edge marginal region with stitching to attach a flange, pocket, pouch, sack, cone, spherical dome, or compartment shape to account for cooking vessel handles, handgrips, and knobs.

11. The cooking apparatus defined in claim 9 wherein the attachment about any common edge marginal region consisting of hook and loop, rivets, snaps, buttons, grommets, or adhesive.

12. The cooking apparatus defined in claim 9 wherein the space between the sheets includes one or more insulating padding elements.

13. The cooking apparatus defined in claim 9 including a loop attached to the sheets adjacent to said flaps for removably supporting the sheets from a support member.

14. The cooking apparatus defined in claim 9 wherein the flange surface, the top surface, the underside surface or any other suitable surface covered with a gripping substance, which can be composed of materials such as rubber, polyurethane, silicone, synthetic rubber, vinyl, or the like.

15. The cooking apparatus defined in claim 1 including the sheets fabricated with crochet, knitting, macrame, lace, trim, or the like.

16. A cooking apparatus comprising: a single sheet forming an open, slightly curved, spherical dome or cone shape which follows the contour of most pots, pans and cooking vessels tops, covers and/or lids: the sheet being characterized as heat and cold temperature resistant and naturally fire retardant; the sheet being measured as somewhere between 0.80 mm to 40 mm thick; the sheet forming a pocket near the center to account for handles and knobs; the sheet normally forming an open, curved, spherical section shape which follows the contour of most pots, pans and cooking vessels tops, covers and/or lids; the sheet made from molded silicone, urethane, vinyl, synthetic rubber, or other flexible heat resistant moldable rubber or plastic.

17. The cooking apparatus defined in claim 16 wherein molded in, on or attached onto, at the center edge marginal region a flange, pocket, pouch, sack, cone, spherical dome or other compartment shape to account for cooking vessel handles, handgrips, and knobs.

18. The cooking apparatus defined in claim 16 wherein textures, ribs, bumps, dots or other shapes are molded in or onto the surfaces for structure, style and/or gripping purposes.

19. The cooking apparatus defined in claim 16 including a hole molded into or punched through the sheet for branding tags and/or for removably supporting the sheet from a support member.

20. The cooking apparatus defined in claim 16 including a loop molded onto or into the sheet for branding tags and/or for removably supporting the sheet from a support member.
